(19) United States
(12) Patent Application Publication
(10) Pub. No.: US 2017/0122233 A1
(43) Pub. Date: May 4, 2017

(54) Exhaust Gas Recirculation System

(71) Applicants: DENSO International America, Inc., Southfield, MI (US); DENSO CORPORATION, Kariya-shi (JP)

(72) Inventors: Blaise DIDONATO, Commerce Township, MI (US); Mark WILLIAMS, Gaines, MI (US)

(21) Appl. No.: 14/928,250

(22) Filed: Oct. 30, 2015

(51) Int. Cl. F02D 41/00; F02M 26/21; F02M 26/44; F02M 26/53

(52) U.S. Cl. CPC F02D 41/0077; F02M 26/53; F02M 26/21; F02M 26/44

(57) ABSTRACT

A dedicated exhaust gas recirculation (EGR) system. The EGR system includes a plurality of flow restriction devices, each one of which is associated with a different one of a plurality of EGR conduits leading to air runners of an air manifold in order to control delivery of exhaust gas to the air runners. The air runners are configured to direct air and exhaust gas to the engine cylinders.

### FIELD

The present disclosure relates to an exhaust gas recirculation system.

### BACKGROUND

This section provides background information related to the present disclosure, which is not necessarily prior art.

Exhaust gas recirculation (EGR) is a nitrogen oxide (NOx) emissions reduction technique used in internal combustion engines. EGR works by recirculating a portion of an engine's exhaust gas back to the engine cylinders. This dilutes the O₂ in the incoming air stream and provides gases inert to combustion to act as absorbents of combustion heat to reduce peak in-cylinder temperatures. NOx is produced in a narrow band of high cylinder temperatures and pressures.

In a gasoline engine, this inert exhaust displaces the amount of combustible matter in the cylinder. In a diesel engine, the exhaust gas replaces some of the excess oxygen in the pre-combustion mixture. Because NOx forms primarily when a mixture of nitrogen and oxygen is subjected to high temperature, the lower combustion chamber temperatures caused by EGR reduces the amount of NOx the combustion generates (though at some loss of engine efficiency). Gasses re-introduced from EGR systems will also contain near equilibrium concentrations of NOx and CO; the small fraction initially within the combustion chamber inhibits the total net production of these and other pollutants when sampled on a time average.

While current EGR systems are suitable for their intended use, they are subject to improvement. The present teachings provide for EGR systems that address various shortcomings experienced with current EGR systems, and provide numerous unexpected results. For example, the present teachings advantageously provide for a balanced delivery of recirculated exhaust gas to the engine cylinders across a given engine RPM range.

### SUMMARY

This section provides a general summary of the disclosure, and is not a comprehensive disclosure of its full scope or all of its features.

The present teachings are directed to a dedicated exhaust gas recirculation (EGR) system. The EGR system includes a plurality of flow restriction devices, each one of which is associated with a different one of a plurality of EGR conduits leading to engine cylinders to control delivery of exhaust to air runners configured to direct air to the engine cylinders.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates a dedicated exhaust gas recirculation (EGR) system according to the present teachings;

FIG. 2A illustrates the dedicated EGR system of FIG. 1 with a fourth engine cylinder on an exhaust stroke, and a third engine cylinder on an intake stroke;

FIG. 2B illustrates the dedicated EGR system with the fourth cylinder on an intake stroke and a second cylinder on an exhaust stroke;

FIG. 2C illustrates the dedicated EGR system with the second cylinder on an intake stroke and a first cylinder on an exhaust stroke; and

FIG. 2D illustrates the dedicated EGR system with the third cylinder on an exhaust stroke and the first cylinder on an intake stroke.

Corresponding reference numerals indicate corresponding parts throughout the several views of the drawings.

### DETAILED DESCRIPTION

Example embodiments will now be described more fully with reference to the accompanying drawings.

The present teachings are directed to an internal combustion engine (“ICE”). The ICE can be of any type, such as a piston-cylinder engine or a Wankel engine, for example. The ICE may be configured to run on any type of suitable fuel, such as diesel, gasoline, ethanol, or natural gas for example. The ICE may be located within a vehicle, such as an automobile, truck, machinery, aircraft, watercraft, or any other vehicle to provide power for locomotion, for example. However, it is also contemplated that the ICE could be used in other applications with or without a vehicle, such as an electrical generator, or to operate machinery, for example.

A dedicated exhaust gas recirculation (EGR) system according to the present teachings is generally illustrated throughout the Figures at reference numeral 10. The dedicated EGR system 10 includes an engine cylinder block 12 having any suitable number of cylinders. For example and as illustrated, the engine cylinder block 12 can have a first cylinder 14, a second cylinder 16, a third cylinder 18, and a fourth cylinder 20. Any other suitable number of cylinders can be provided, such as 8 cylinders or 12 cylinders, for example. Any of the cylinders 14, 16, 18, 20 can be configured as a dedicated EGR cylinder, such as the fourth cylinder 20 as illustrated in the exemplary dedicated EGR system 10.

The dedicated EGR system 10 further includes an air manifold 22. The air manifold 22 has an air inlet pipe 24 configured to direct airflow into the air manifold 22. The airflow is from the external environment, and is generally clean airflow. A plurality of air runners extend from the air manifold 22, and are arranged to direct airflow to the engine cylinder block 12. Specifically, a first air runner 26 extends from the air manifold 22 to the first cylinder 14. A second air runner 28 extends from the air manifold 22 to the second cylinder 16. A third air runner 30 extends from the air manifold 22 to the third cylinder 18. A fourth air runner 32 extends from the air manifold 22 to the fourth cylinder 20.

The system 10 further includes a plurality of conduits extending from each one of the cylinders 14, 16, 18, 20 to direct exhaust gas away from the engine cylinder block 12. Specifically, a first outlet pipe 34 extends from the first cylinder 14 to direct exhaust gas away from the first cylinder 14. A second outlet pipe 36 extends from the second cylinder 16 to direct exhaust gas away from the second cylinder 16. A third outlet pipe 38 extends from the third cylinder 18 to direct exhaust gas away from the third cylinder 18.

The dedicated EGR system 10 includes an EGR manifold 50 arranged to direct exhaust gas away from the fourth cylinder 20, which is a dedicated EGR cylinder. The EGR manifold 50 extends from the fourth cylinder 20, and branches off into a plurality of different exhaust gas delivery conduits or runners. Specifically, a first exhaust gas delivery conduit or runner 52 extends to the first air runner 26. A second exhaust gas delivery conduit or runner 54 extends to the second air runner 28. A third exhaust gas delivery conduit or runner 56 extends to the third air runner 30. A fourth exhaust gas delivery conduit or runner 58 extends to the fourth air runner 32.

The air runners 26, 28, 30, 32 each define an opening through which exhaust gas from the fourth cylinder 20 enters the air runners 26, 28, 30, 32 by way of the first, second, third, or fourth exhaust gas delivery conduits or runners 52, 54, 56, 58 respectively. Specifically, the first air runner 26 defines a first opening 60. The first exhaust gas delivery conduit or runner 52 is coupled to the first air runner 26 at the opening 60 in order to deposit exhaust gas into the first air runner 26. The second air runner 28 defines a second opening 62, at which the second exhaust gas delivery conduit or runner 54 is coupled to the second air runner 28 in order to deposit exhaust gas into the second air runner 28. The third air runner 30 defines a third opening 64, at which the third exhaust gas delivery conduit or runner 56 is coupled to the third air runner 30 in order to deposit exhaust gas into the third air runner 30. The fourth air runner 32 defines a fourth opening 66, at which the fourth exhaust gas delivery conduit or runner 58 is coupled to the fourth air runner 32 in order to deposit exhaust gas into the fourth air runner 32.

To control the flow of exhaust gas from the fourth cylinder 20 to the air runners 26, 28, 30, 32, each one of the exhaust gas delivery conduits or runners 52, 54, 56, 58 includes a flow restrictor. For example, the first exhaust gas delivery conduit or runner 52 includes a first flow restrictor 70. The second exhaust gas delivery conduit or runner 54 includes a second flow restrictor 72. The third exhaust gas delivery conduit or runner 56 includes a third flow restrictor 74. The fourth exhaust gas delivery conduit or runner 58 includes a fourth flow restrictor 76. The flow restrictors 70, 72, 74, 76 can be any suitable flow restrictors, such as flow restrictors configured to be electronically actuated or controlled by a controller 80.

The controller 80 can be any suitable controller configured to control the flow restrictors 70, 72, 74, 76 to direct a desired amount of exhaust gas to the air runners 26, 28, 30, 32. For example, the controller 80 can include any suitable processor hardware that executes code and memory hardware that stores code executed by the processor hardware for controlling delivery of exhaust gas to the air runners 26, 28, 30, 32. For example, the controller 80 can be configured to electronically control/actuate the flow restrictors 70, 72, 74, 76 to provide a balanced delivery of exhaust gas to the air runners 26, 28, 30, 32 at an amount or rate that varies depending on the engine RPM rate in order to customize the amount of exhaust gas deposited to the air runners 26, 28, 30, 32 based on the speed of the engine. The flow restrictors 70, 72, 74, 76 can be any suitable flow restrictors, such as any suitable valves, including any suitable butterfly valve, poppet valve, or flapper valve.

To prevent the backflow of exhaust gas out of the air runners 26, 28, 30, 32, the exhaust gas delivery conduits or runners 52, 54, 56, 58 can include check valves 90, 92, 94, 96 respectively. Specifically, the first exhaust gas delivery conduit or runner 52 includes a first check valve 90 between the first flow restrictor 70 and the opening 60. The second exhaust gas delivery conduit or runner 54 includes a second check valve 92 between the second flow restrictor 72 and the opening 62. The third exhaust gas delivery conduit or runner 56 includes a third check valve 94 between the third flow restrictor 74 and the opening 64. The fourth exhaust gas delivery conduit or runner 58 includes a fourth check valve 96 between the fourth flow restrictor 76 and the opening 66.

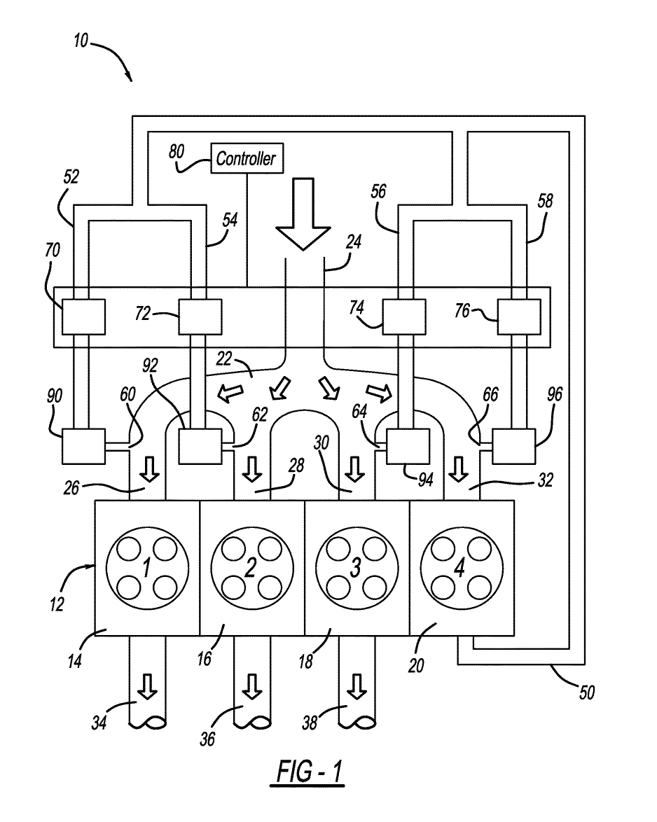

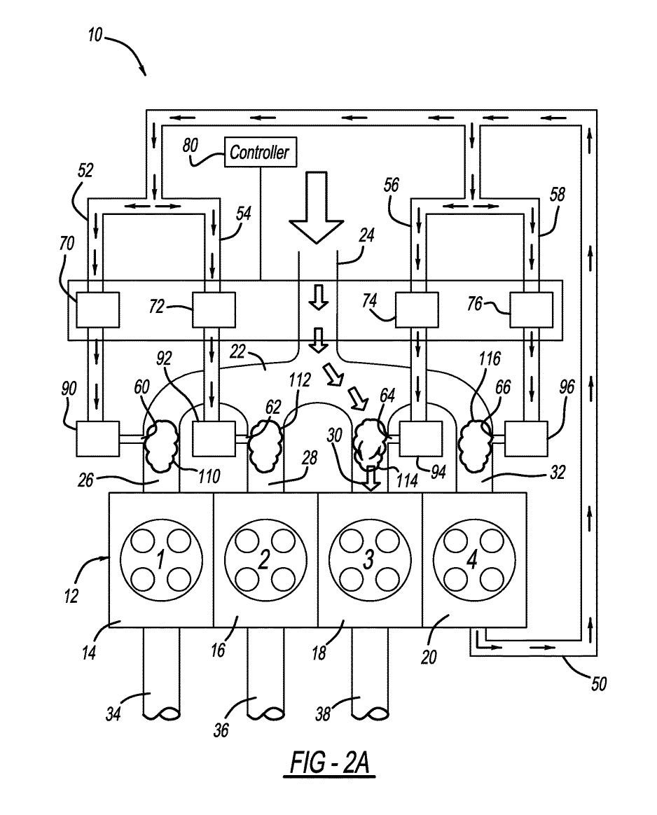

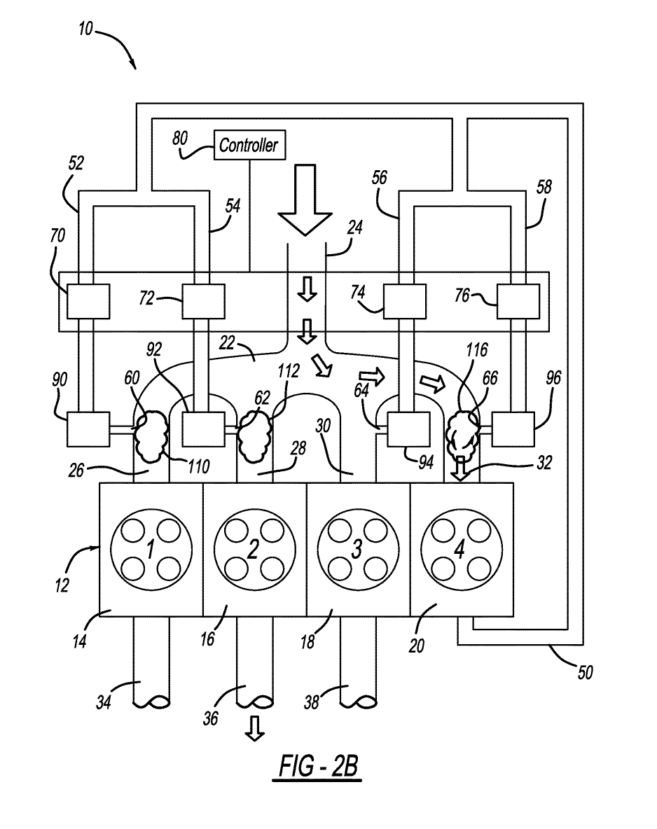

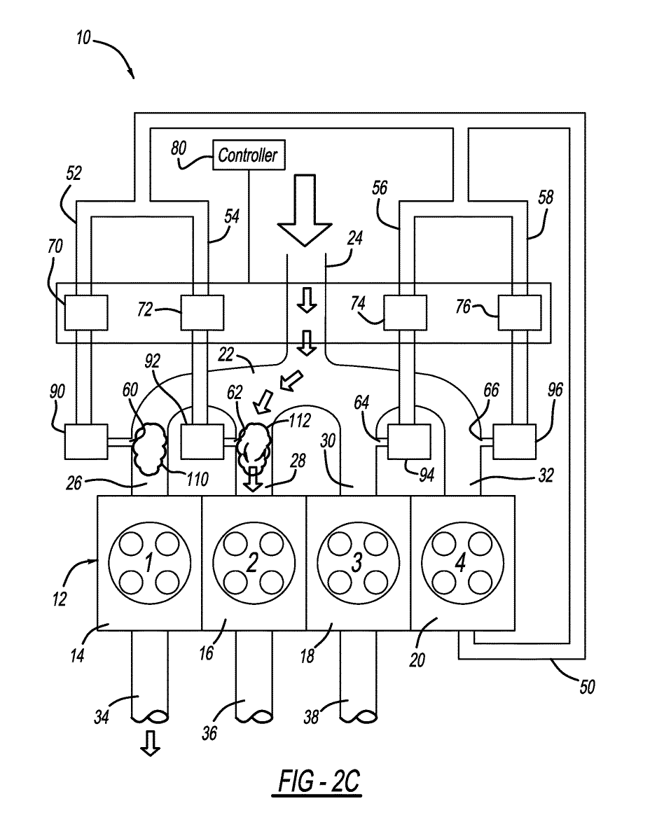

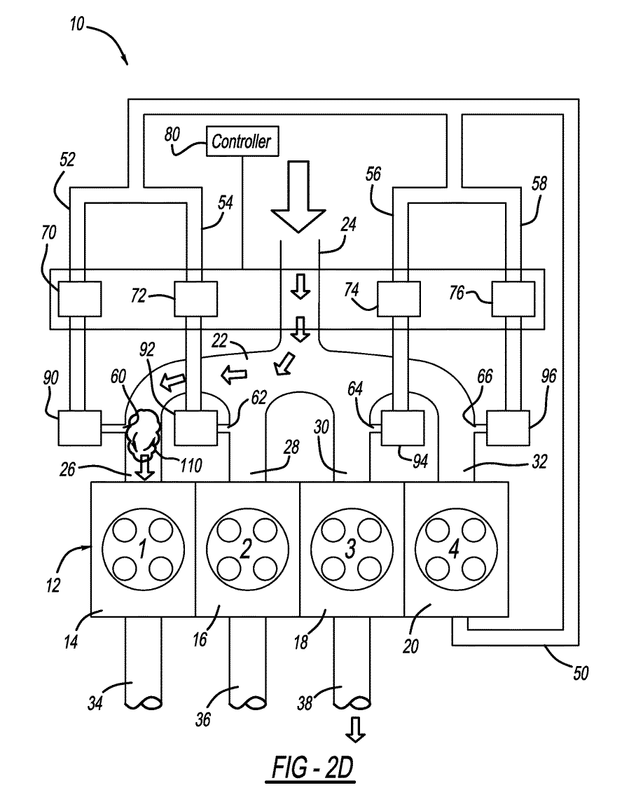

With continued reference to FIG. 1 and additional reference to FIGS. 2A through 2D, an exemplary method of operation for the dedicated EGR system 10 will now be described. With initial reference to FIG. 2A, during an exemplary first cycle, the fourth cylinder 20 is on an exhaust stroke, thereby releasing exhaust into the EGR manifold 50. The exhaust gas flows through the EGR manifold 50 to each one of the first, second, third, and fourth exhaust gas delivery conduits or runners 52, 54, 56, and 58. The controller 80 controls the flow restrictors 70, 72, 74, 76 to balance the delivery of exhaust gas into the air runners 26, 28, 30, 32. As a result, stagnant exhaust gas 110 is deposited in the first air runner 26, stagnant exhaust gas 112 is deposited in the second air runner 28, stagnant exhaust gas 114 is deposited in the third air runner 30, and stagnant exhaust gas 116 is deposited in the fourth air runner 32. As explained above, the amount of stagnant exhaust gas 110, 112, 114, and 116 deposited is varied by the controller 80 according to the RPM engine speed through control of the flow restrictors 70, 72, 74, 76. Simultaneously, the third cylinder 18 is on an intake stroke, which draws air from the air manifold 22 into the third air runner 30 where air mixes with the stagnant exhaust gas 114, and is then drawn into the third cylinder 18. An exemplary target for the amount of exhaust gas entering the cylinders 14, 16, 18, and 20 during an intake stroke is 25% of the total intake.

With reference to FIG. 2B, during a second engine cycle, the second cylinder 16 is on an exhaust stroke, which results in exhaust gas being expelled from the second cylinder 16 into the second outlet pipe 36. Simultaneously, the fourth cylinder 20 is on an intake stroke, which draws air from the air manifold 22 into the fourth air runner 32 where the air mixes with the stagnant exhaust gas 116 to provide a mixture of exhaust gas and air, which is delivered to the fourth cylinder 20.

With reference to FIG. 2C, a third engine cycle is illustrated in which the first cylinder 14 is on an exhaust stroke, which results in exhaust gas being expelled from the first cylinder 14 into the first outlet pipe 34. Simultaneously, the second cylinder 16 is on an intake stroke. During the intake stroke, air from the air manifold 22 mixes with the stagnant exhaust gas 112 in the second air runner 28, to form a mixture of exhaust gas and air, which is delivered to the second cylinder 16.

With reference to FIG. 2D, a fourth cycle is illustrated in which the third cylinder 18 is on an exhaust stroke, which results in exhaust gas being expelled from the third cylinder 18 into the third outlet pipe 38. Simultaneously, the first cylinder 14 is on an intake stroke, which results in air from the air manifold 22 mixing with the stagnant exhaust gas 110 in the first air runner 26. The mixture of air and exhaust gas in the first air runner 26 is delivered to the first cylinder 14. After the fourth cycle of FIG. 2D is complete, the engine cycle repeats. The cylinders 14, 16, 18, and 20 can be configured to operate in any suitable firing order. In the example illustrated, the cylinder firing order is 3-4-2-1-3-4-2-1. However, any other suitable firing order can be provided.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used is for the purpose of describing particular example embodiments only and is not intended to be limiting. The singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). The term “and/or” includes any and all combinations of one or more of the associated listed items.

Although the terms first, second, third, etc. may be used to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A dedicated exhaust gas recirculation (EGR) system comprising:
an engine cylinder block including a plurality of cylinders, one of which is a dedicated EGR cylinder;
an air manifold and a plurality of air runners extending therefrom, each one of the plurality of air runners extending to the engine cylinder block and associated with a different one of the plurality of cylinders in order to deliver air to the plurality of cylinders;
an EGR manifold and a plurality of EGR runners extending therefrom, each one of the EGR runners extending to a different one of the air runners to deliver exhaust gas thereto; and
a plurality of flow restriction devices, each one of which is associated with a different one of the plurality of EGR runners to control delivery of exhaust to the air runners.

2. The dedicated EGR system of claim 1, further comprising a controller configured to control the plurality of flow restriction devices to balance delivery of exhaust gas to the plurality of air runners at different engine RPM ranges.

3. The dedicated EGR system of claim 1, wherein the plurality of flow restriction devices are electronically controlled.

4. The dedicated EGR system of claim 1, wherein the plurality of flow restriction devices are electronically controlled valves including at least one of a butterfly valve, a poppet valve, and a flapper valve.

5. The dedicated EGR system of claim 1, further comprising a plurality of check valves, each one of which is associated with a different one of the air runners to prevent flow of exhaust gas from the air runners to the EGR runners.

6. The dedicated EGR system of claim 1, wherein an exhaust stroke of the dedicated EGR cylinder results in exhaust being deposited within each one of the EGR runners.

7. The dedicated EGR system of claim 1, wherein during an intake stroke of any one of the plurality of cylinders, air from the air manifold mixes with exhaust gas in the air runner associated with the cylinder on the intake stroke to form a mixture of exhaust gas and air that enters the cylinder on the intake stroke.

8. The dedicated EGR system of claim 1, wherein the plurality of flow restriction devices are configured such that an intake of each one of the plurality of cylinders is 25% exhaust gas.

9. The dedicated EGR system of claim 1, wherein the system is configured to permit air to flow freely through the air manifold and the plurality of air runners to the plurality of cylinders in an uncontrolled manner.

10. A dedicated exhaust gas recirculation (EGR) system comprising:
an engine cylinder block having a plurality of cylinders, one of which is a dedicated EGR cylinder;
an air manifold and a plurality of runners extending therefrom, each one of the plurality of runners extending to the engine cylinder block and associated with a different one of the plurality of cylinders in order to deliver air to the plurality of cylinders;
an EGR manifold extending from the dedicated EGR cylinder to direct exhaust away from the EGR cylinder;
a plurality of EGR delivery conduits extending from the EGR manifold, each one of the plurality of EGR delivery conduits extending to a different one of the plurality of runners to direct exhaust to the plurality of runners; and
a plurality of flow restriction devices, each one of which is controlled by a controller and associated with a different one of the plurality of EGR delivery conduits to control passage of exhaust gas through the EGR delivery conduits to the runners;
wherein the controller is configured to control the plurality of flow restriction devices to balance delivery of exhaust gas to the plurality of runners at different engine RPM ranges.

11. The dedicated EGR system of claim 10, wherein the plurality of flow restriction devices are electronically controlled valves including at least one of a butterfly valve, a poppet valve, and a flapper valve.

12. The dedicated EGR system of claim 10, further comprising a plurality of check valves, each one of which is associated with a different one of the runners to prevent flow of exhaust gas from the runners to the EGR delivery conduits.

13. The dedicated EGR system of claim 10, wherein an exhaust stroke of the dedicated EGR cylinder results in exhaust being deposited within each one of the runners.

14. The dedicated EGR system of claim 10, wherein:
during an intake stroke of any one of the plurality of cylinders, air from the air manifold mixes with exhaust gas in the runner associated with the cylinder on the intake stroke to form a mixture of exhaust gas and air that enters the cylinder on the intake stroke; and
the system is configured to permit air to flow freely through the air manifold and the plurality of air runners to the plurality of cylinders in an uncontrolled manner.

15. A dedicated exhaust gas recirculation (EGR) system comprising:
an engine cylinder block having a plurality of cylinders, one of which is a dedicated EGR cylinder;
an air manifold and a plurality of air runners extending therefrom, each one of the plurality of air runners extending to the engine cylinder block and associated with a different one of the plurality of cylinders in order to deliver air to the plurality of cylinders;
an EGR manifold and a plurality of EGR runners extending therefrom, each one of the EGR runners extending to a different one of the air runners to deliver exhaust gas thereto;
a plurality of flow restriction valves, each one of which is associated with a different one of the plurality of EGR runners to control delivery of exhaust to the air runners;
a controller configured to electronically control the plurality of flow restriction valves;
wherein:
the controller is configured to open the plurality of flow restriction valves during an exhaust stroke of the dedicated EGR cylinder to permit exhaust from the dedicated EGR cylinder to flow to the air runners, and to balance delivery of exhaust gas to the plurality of air runners at different engine RPM ranges; and
during an intake stroke of any one of the plurality of cylinders, air from the air manifold mixes with exhaust gas in the air runner associated with the cylinder on the intake stroke to form a mixture of exhaust gas and air that enters the cylinder on the intake stroke.

16. The dedicated (EGR) system of claim 15, further comprising a plurality of check valves, each one of which is associated with a different one of the EGR runners to prevent flow of exhaust gas from the air runners to the EGR runners.

17. The dedicated EGR system of claim 15, wherein the system is configured to permit air to flow freely through the air manifold and the plurality of air runners to the plurality of cylinders in an uncontrolled manner.

18. The dedicated EGR system of claim 15, wherein the engine cylinder block includes at least four cylinders.

19. The dedicated EGR system of claim 15, wherein the engine cylinder block includes only four cylinders.

20. The dedicated EGR system of claim 15, wherein the plurality of flow restriction devices are configured such that each one of the plurality of cylinders combusts 25% exhaust gas.
